(19) United States
(12) Patent Application Publication
(10) Pub. No.: US 2008/0087488 A1
(43) Pub. Date: Apr. 17, 2008

(54) System and Method for Automatic Steering

(75) Inventor: Ron Palmer, Regina (CA)

Correspondence Address: MIDDLETON & REUTLINGER, 2500 BROWN & WILLIAMSON TOWER, LOUISVILLE, KY, 40202, US

(73) Assignee: Accutrak Systems Limited

(21) Appl. No.: 11/547,272

(22) PCT Filed: Jun. 13, 2006
(86) PCT No.: PCT/CA06/00945

§ 371 Date: Oct. 2, 2006

Related U.S. Application Data
(60) Provisional application No. 60/690,343, filed on Jun. 14, 2005.

(30) Foreign Application Priority Data
Jun. 14, 2005 (CA) 2,509,888

(51) Int. Cl. B60K 17/10; G06F 19/00

(52) U.S. Cl. 180/308; 701/41

(57) ABSTRACT

An apparatus and method for automatically steering a vehicle with hydrostatic steering is provided. The vehicle has a right hydraulic motor and a left hydraulic motor connected to right and left drive wheels, respectively. A pressurized hydraulic fluid source supplies a hydraulic fluid flow to the hydraulic motors, driving the wheels. A control valve system can divert a portion of a hydraulic fluid flow to either the right or left hydraulic motor, in response to a control signal from a control system, causing the hydraulic motor to slow the rotation of the connected wheel, turning the vehicle. The vehicle is automatically steered by the control system determining a steering direction required to steer the vehicle and causing a portion of a hydraulic fluid flow to a hydraulic motor driving a wheel of the vehicle to be diverted, slowing the wheel and steering the vehicle.

This invention is in the field of control equipment for vehicles with hydrostatic drives and more specifically for control systems incorporating auto-steering capabilities.

### BACKGROUND

There are numerous control systems on the market that can determine a desired vehicle path of an agricultural vehicle and then invoke a vehicle steering actuator system to maintain the agricultural vehicle along the desired vehicle path. Typically, these control systems are used to guide an agricultural vehicle on a desired path, for planting, spraying harvesting, etc. First, a desired path in a field to be planted, sprayed, harvested, etc. is determined by the control system and the control system will then attempt to cause the agricultural vehicle to move in a desired adjacent path after each pass of the agricultural vehicle making more ideal adjacent paths.

These control systems typically comprise a microprocessor and require some type of input that allows the control system to determine the position and/or direction of travel of the agricultural vehicle. Typically, these systems will use a GPS device to determine the position of the agricultural device, although other position determining methods such as dead reckoning, marker triangulation, etc. can also be used. Some more sophisticated systems combine GPS devices that determine the position of the agricultural vehicle in conjunction with gyroscopes to determine the direction of travel of the agricultural for a more precise determination of the position and direction of travel of the agricultural vehicle. Using these inputs, the control system repeatedly determines the position of the agricultural vehicle and compares the determined position to a desired path. If the agricultural vehicle has deviated or is deviating from the desired path, the control system can guide the agricultural vehicle back to the desired path.

Although many of these control systems guide the vehicle back to a desired path by simply indicating to the operator a direction to steer the vehicle in order to move back to the desired path, some of the more sophisticated systems use a steering actuator system to automatically steer the vehicle back to the desired path, independently from any inputs provided by the operator of the vehicle. These control systems incorporating automatic steering systems have previously been used on agricultural vehicles with standard hydraulic steering. In these standard hydraulic steering systems, an operator enters steering inputs, such as by turning a steering wheel, and these steering inputs are transmitted to a hydraulic system that routes hydraulic fluid to the steering components. When the operator turns the agricultural vehicle to the right, hydraulic pressure is used to cause a pairs of wheels of the vehicle to pivot around a vertical axis, turning the front wheels of the agricultural vehicle to the right and vice versa to turn the vehicle to the left. These steering systems comprise a hydraulic pump to pressurize the hydraulic fluid. A fluid router is connected to the manual steering controls of the agricultural vehicle and using the inputs from the operator, the fluid router routes the pressurized hydraulic fluid to turn a pair of direction wheels to the right or left. Steering actuators for these types of systems typically route pressurized hydraulic fluid around the fluid router. When the control system determines the agricultural vehicle is diverting from the desired vehicle path, the control system can route this pressurized fluid to the steering system of the agricultural vehicle giving the control system the ability to steer the agricultural vehicle independently from the steering inputs of an operator.

While these prior art systems have proven themselves workable on standard steering systems, they have not been as successful on agricultural vehicles that have hydrostatic steering. Vehicles with hydrostatic steering do not pivot a pair of directional wheels around a vertical axis in order to steer the vehicle. Rather, vehicles with hydrostatic steering use a differential in rotational velocity between the driving wheels on the right and left of the vehicle to turn the vehicle. Each of a pair of driving wheels is driven by its own hydraulic motor. To move the vehicle in a straight line, an equal flow of pressurized hydraulic fluid is routed to both of the hydraulic motor driving each of the wheels causing the left and right driving wheels to rotate at the same speed and causing the vehicle to move in a straight line. In order to turn the vehicle to the right, more pressurized hydraulic fluid is routed to left hydraulic motor driving the left wheel causing the left drive wheel to rotate faster than the right wheel with the result that the vehicle turns to the right. Alternatively, less pressurized hydraulic fluid can be routed to the right wheel to also cause the vehicle to turn to the right. In contrast the same process is used in the opposite manner to turn the vehicle to the left.

Trying to retrofit a conventional automatic steering actuator system to a hydrostatic steering system has been problematic. More conventional hydraulic steering systems with directional wheels operate using lower hydraulic pressures than hydrostatic steering systems because only enough hydraulic pressure is required to pivot the wheels about a vertical axis. Hydraulic drive systems on the other hand, require enough pressure to drive the drive wheels and move the entire vehicle rather than just pivoting the steering wheels. Routing this highly pressurized hydraulic fluid in a hydrostatic system to the outside drive wheel to cause the vehicle to turn results in erratic steering and unsatisfactory operation of these auto-steer systems.

### SUMMARY OF THE INVENTION

It is an object of the present invention to overcome problems in the prior art.

In a first aspect of the invention, a vehicle with hydrostatic steering and an automatic steering system is provided. The vehicle comprises: a pressurized hydraulic fluid source; a right hydraulic motor operative to drive a right drive wheel and operably connected to the pressurized hydraulic fluid source by a right drive conduit, wherein the right hydraulic motor is driven by a right hydraulic fluid flow from the right drive conduit; a left hydraulic motor operative to drive a left drive wheel and operably connected to the pressurized hydraulic fluid source by a left drive conduit, wherein the left hydraulic motor is driven by a left hydraulic fluid flow from the left drive conduit; a manual steering control for manual steering of the vehicle; a hydraulic circuit operative to selectively vary the left hydraulic fluid flow and right hydraulic fluid flow, in response to inputs from the manual steering control; a right diverting conduit operatively connected to the right drive conduit upstream from the right hydraulic motor; a left diverting conduit operatively connected to the left drive conduit upstream from the left hydraulic motor; a control system operative to determine a desired direction of travel and generate a control signal corresponding to the desired direction of travel; and a control valve system operative to open a flow path through the right diverting conduit, in response to a right control signal from the control system and open a flow path through the left diverting conduit, in response to a left control signal from the control system. The vehicle can be automatically steered in a left direction by the control system generating a left control signal and the control valve system opening the flow path through the left diverting conduit in response to the left control signal to route a portion of the left hydraulic fluid flow away from the left drive motor and wherein the vehicle can be automatically steered in a right direction by the control system generating a right control signal and the control valve system opening the flow path through the right diverting conduit in response to the right control signal to route a portion of the right hydraulic fluid flow away from the right drive motor.

In a second aspect of the invention, a kit for adding automatic steering capabilities to a vehicle with hydrostatic steering is provided. The vehicle comprises: a pressurized hydraulic fluid source; a right hydraulic motor operative to drive a right drive wheel and operably connected to the pressurized hydraulic fluid source by a right drive conduit, wherein the right hydraulic motor is driven by a right hydraulic fluid flow from the right drive conduit; a left hydraulic motor operative to drive a left drive wheel and operably connected to the pressurized hydraulic fluid source by a left drive conduit, wherein the left hydraulic motor is driven by a left hydraulic fluid flow from the left drive conduit; a manual steering control for manual steering of the vehicle; a hydraulic circuit operative to selectively vary the left hydraulic fluid flow and right hydraulic fluid flow, in response to inputs from the manual steering control; and a control system operative to determine a desired direction of travel and generate a control signal corresponding to the desired direction of travel. The kit comprising: a right diverting conduit connectable to the right drive conduit of the vehicle upstream from the right hydraulic motor; a left diverting conduit connectable to the left drive of the vehicle conduit upstream from the right hydraulic motor; and a control valve system operatively connectable to the control system and operative to open a flow path through the right diverting conduit, in response to a right control signal from the control system and open a flow path through the left diverting conduit, in response to a left control signal from the control system. The kit allows the vehicle to be automatically steered in a left direction by the control system generating the left control signal and the control valve system opening the flow path through the left diverting conduit in response to the left control signal to route a portion of the left hydraulic fluid flow away from the left drive motor and wherein the vehicle can be automatically steered in a right direction by the control system generating the right control signal and the control valve system opening the flow path through the right diverting conduit in response to the right control signal to route a portion of the right hydraulic fluid flow away from the right drive motor.

In a third aspect of the invention, a method of automatically steering a vehicle equipped with hydrostatic steering on a desired path is provided. The method comprises: determining a steering direction required to steer the vehicle on the desired path; and automatically diverting a portion of a hydraulic fluid flow flowing to a hydraulic motor driving a wheel of the vehicle to slow the wheel to steer the vehicle in the steering direction.

The present invention provides, a steering system to be used in conjunction with a control system to automatically steer a vehicle equipped with a hydrostatic drive, independently from any inputs of an operator.

In typical operation, a hydrostatic drive uses pressurized hydraulic fluid to drive a right wheel and a left wheel of a vehicle. The hydraulic fluid is routed by a valve block to a right hydraulic motor that is connected to and rotates a right wheel of the vehicle and to a left hydraulic motor that is connected to and rotates a left wheel of the vehicle. To drive the vehicle in a straight line, the same amount of hydraulic fluid flow is directed to both the right hydraulic motor and left hydraulic motor, causing the right wheel and left wheel to rotate at the same velocity. To turn the vehicle to the right, more hydraulic fluid flow is directed to the left hydraulic motor causing the left drive wheel of the vehicle to rotate faster than the right drive wheel. Alternatively, the vehicle can be turned to the right by decreasing the fluid flow to the right hydraulic motor causing the right drive wheel to rotate slower than the left wheel. To turn the vehicle to the left, either more hydraulic fluid is routed to the right hydraulic motor or less to the left hydraulic motor, causing the right drive wheel to rotate faster in relation to the left drive wheel.

The steering system of the present invention connects into the conduits routing hydraulic fluid to the right hydraulic motor and left hydraulic motor. To turn the vehicle to the right, the steering system diverts hydraulic fluid flow away from the right hydraulic motor causing the right wheel to rotate slower and the vehicle to turn to the right. To turn the vehicle to the left, the steering system diverts hydraulic fluid flow away from the left hydraulic motor causing the left drive wheel to rotate slower and the vehicle to turn to the left.

The steering system turns the vehicle in response to control signals from a control system. The control system can be any of the control systems as known in the prior art that is operative to determine a position of the vehicle and compare it to a desired path. If the vehicle has deviated from a desired path, the control system sends control signals to the steering system that causes the vehicle to turn to the right or left as required to move the vehicle back to the desired path. As the vehicle is turning, the control system will continue, at set intervals, to determine the position of the vehicle and once the vehicle has turned a sufficient amount so that it is once again on the desired path, the control system will stop sending control signals to the steering system and the steering system will stop diverting hydraulic fluid away from the hydraulic fluid motors, causing the steering system to stop turning the vehicle. In some cases where a substantial correction to the direction of travel has been made, the control system may need to turn the vehicle in the opposite direction for a short period of time to straighten it out on the desired path.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic illustration of a conventional hydrostatic drive system;

FIG. 2 is a schematic illustration of a steering system;

FIG. 3 is a schematic illustration of the steering system of FIG. 2, integrated with the hydrostatic drive system of FIG. 1; and

FIG. 4 is a schematic illustration of the steering system of FIG. 2, integrated with the hydrostatic drive system of FIG. 1, in a further variation; and

FIG. 5 is a schematic illustration of an implementation of a control system.

### DETAILED DESCRIPTION OF THE ILLUSTRATED EMBODIMENTS:

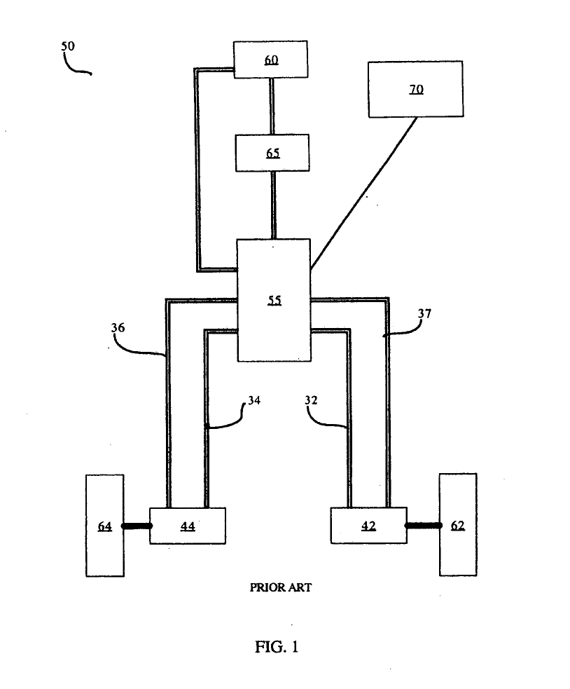

FIG. 1 is a schematic illustration of a conventional hydrostatic drive system of a vehicle as known in the prior art. A conventional hydrostatic drive system, such as the hydrostatic drive system 50 comprises: a right hydraulic motor 44; a left hydraulic motor 42; a right drive conduit 34; a right return conduit 36; a left drive conduit 32; a left return conduit 37; a valve block 55; a tank 60; a pump 65 and a manual steering control 70.

In typical operation of the hydrostatic drive system 50, hydraulic fluid from the tank 60 will be pressurized by the pump 65 and the pressurized hydraulic fluid routed to the valve block 55. The valve block 55 is a hydraulic circuit that can selectively vary the flow of hydraulic fluid. From the valve block 55, this pressurized hydraulic fluid is routed through the right drive conduit 34 to the right hydraulic motor 44 to drive a right wheel 64, connected to the right hydraulic motor 44. From the right hydraulic motor 44, the hydraulic fluid is routed back to the routing valve 55 through a right return conduit 36. To drive a left wheel 62, the pressurized hydraulic fluid is routed through the left drive conduit 32, by the valve block 55, to the left hydraulic motor 42. From the left hydraulic motor 42, the hydraulic fluid is routed back to the routing valve 155 through the left return conduit 37.

An operator controls the vehicle by entering inputs into the manual steering control 70. The manual steering control 70 controls the distribution of the flow of the hydraulic fluid by the valve block 55, as commonly known in the art. Based on the operator's steering inputs, the valve block 55 varies the flow of pressurized fluid to the right hydraulic motor 44 and the left hydraulic motor 42. When an equal flow of hydraulic fluid is provided to the right hydraulic motor 44 and the left hydraulic motor 42, the vehicle will move in a straight direction of travel. By increasing the flow of pressurized hydraulic fluid to the right hydraulic motor 44, so that more hydraulic fluid is flowing to the right hydraulic motor 44 than the left hydraulic motor 42, the right drive wheel 64 of the vehicle is rotated faster than the left drive wheel 62 causing the vehicle to turn to the left. Steering the vehicle to the right is accomplished by increasing the flow of pressurized hydraulic fluid to the left hydraulic motor 42 relative to the right hydraulic motor 44.

Alternatively, the vehicle can also be turned by reducing the flow of hydraulic flow to either the right hydraulic motor 44 or the left hydraulic motor 42. For example, the vehicle can be turned left by left by reducing the amount of hydraulic fluid flowing to the left wheel hydraulic motor 42 causing the right drive wheel 64 to rotate faster relative to the left drive wheel 62 and thereby causing the vehicle to turn left.

While FIG. 1 illustrates a fairly conventional hydrostatic drive system 50, it will be understood that there are well known variations to hydrostatic drive systems that the present invention could also be used with. For example, it is common for some hydrostatic drive systems, rather than using a single speed wheel motor to use multiple speed wheel motors, to provide a wider range of speeds the vehicle with the hydrostatic drive is capable of obtaining. The present invention can just as easily be incorporated into a hydrostatic drive system incorporating multiple speed hydraulic motors.

Additionally, while some hydrostatic drive systems such as the hydrostatic drive system 50 illustrated in FIG. 1 drive a pair of drive wheels 62, 64 (either as wheels or as part of a track system), some hydrostatic drive systems have further elements, such as chain-based transfer systems that allow each hydraulic motor to drive more than a single wheel. The present invention is equally applicable to these types of variations in hydrostatic drive systems.

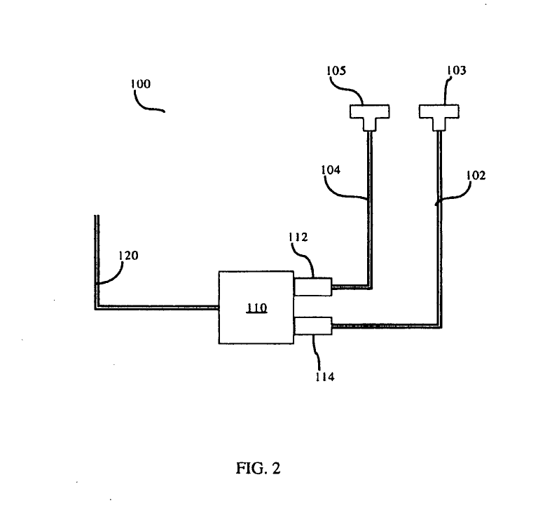

FIG. 2 schematically illustrates a steering system 100 for a vehicle with a hydrostatic drive, in accordance with the present invention. The steering system 100 comprises: a left diverting conduit 102, a left tee connection 103; a right diverting conduit 104, a right tee connection 105; a control valve system 110; and a return conduit 120. Generally, although not necessarily, a right flowrate valve 112 and left flowrate valve 114 can also be provided to allow the flowrate of hydraulic flow in the right diverting conduit 104 and left diverting conduit 102 to be adjusted.

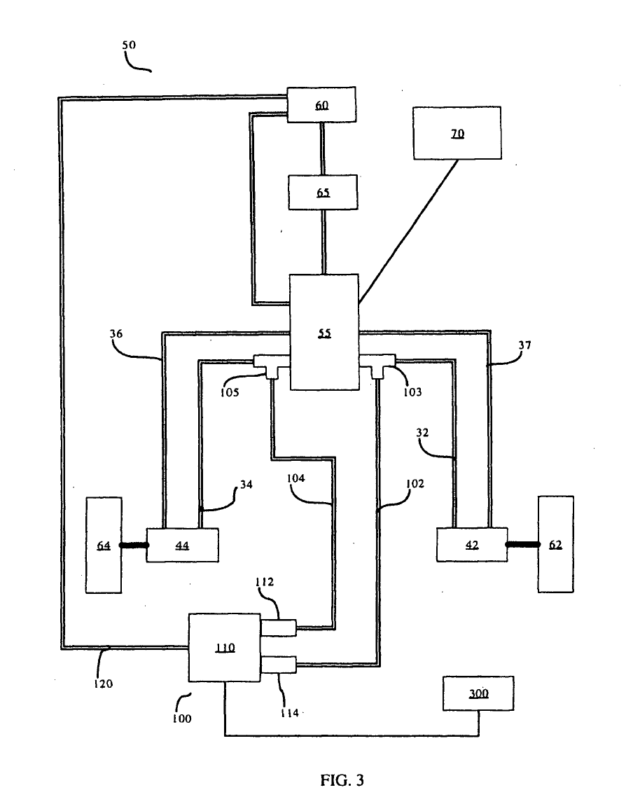

FIG. 3 is a schematic illustration of the steering system 100, illustrated in FIG. 2, incorporated into the hydrostatic drive system 50, illustrated in FIG. 1. The left diverting conduit 102 is operative to contain a flow of hydraulic fluid and is connected into the left drive conduit 32, typically using the left tee connection 103, such that the left diverting conduit 102 is operative to divert a portion of a flow of hydraulic fluid out of or away from the left drive conduit 32 so that the portion of the hydraulic fluid that is diverted by the left divert conduit 102 does not drive the left hydraulic motor 42. The right diverting conduit 104 is operative to contain a flow of hydraulic fluid and is connected into the right drive conduit 34, typically using the right tee connection 105, such that the right drive diverting conduit 104 is operative to divert a portion of a flow of hydraulic fluid out of or away from the right drive conduit 34 so that the portion of the hydraulic fluid that is diverted by the right divert conduit 104 does not drive the right hydraulic motor 44.

The control valve system 110 is typically an open center solenoid valve operative to selectively control the flow of hydraulic fluid through the right diverting conduit 104 and the left diverting conduit 102. The control valve system 110, in response to a control signal from a control system 300, can open a flowpath and route a flow of hydraulic fluid through either the right diverting conduit 104 or left diverting conduit 102 to the return conduit 120 and back to the tank 60. Although FIGS. 2 and 3 show the control circuit 110 as being connected to both the right diverting conduit 104 and the left diverting conduit 102, it would be understood by a person skilled in the art that there could be a separate control valve system 110 for each of the right diverting conduit 104 and left diverting conduit 102 and that a single control circuit does not necessarily have to be used to control the flow through both the right diverting conduit 104 and left diverting conduit 102.

The control valve system 110 could comprise one or more valves that simply open or shut a flow path through the control valve system 110 to the return conduit 120 and the control valve system 110 simply routes hydraulic fluid flow through either the right diverting conduit 104 or left diverting conduit 102, a period of time, to control the steering of the vehicle. Optionally, if the control valve system 110 simply either stops all flow of hydraulic fluid in the right diverting conduit 104 and the left diverting conduit 102 or opens a fluid flowpath for the right diverting conduit 104 or left diverting conduit 102, the right flowrate valve 112 and left flowrate valve 114 could be used to adjust the flowrate of hydraulic fluid through the right diverting conduit 104 and left diverting conduit 102 when a flow path is opened by the control valve system 110, thereby adjusting the turning rate caused by the steering system 100. The right flowrate valve 112 and left flowrate valve 114 are adjustable flowrate valves that can be adjusted for a set flow rate. Typically, the right flowrate valve 112 and the left flowrate valve 114 are manually adjustable needle valves allowing the flowrates in the right diverting conduit 104 and the left diverting conduit 102 to be adjusted.

Alternatively, the control valve system 110 could comprise a proportional valve system and the control valve system 110 could be operative to allow varying amounts of fluid flow through the right diverting conduit 104 and the left diverting conduit 102.

The steering system 100 of the present invention allows a control system 300 to steer a vehicle with a hydrostatic drive, independent of steering inputs from an operator of the vehicle. By inducing hydraulic fluid flow through the right diverting conduit 104, hydraulic fluid flow is diverted away from the right hydraulic motor 44. By reducing the flow of hydraulic fluid to the right hydraulic motor 44, the rotational speed of a right drive wheel 64 being driven by the right hydraulic motor 44 is reduced and the vehicle will turn towards the right. Alternatively by inducing hydraulic fluid flow through the left diverting conduit 102, hydraulic fluid flow is diverted away from the left hydraulic motor 42, which will in turn reduce the flow of hydraulic fluid to the left hydraulic motor 42 causing the left drive wheel 62 to rotate slower and the vehicle to turn to the left.

Hydraulic fluid routed through the right diverting conduit 102 or left diverting conduit 104, by the control valve system 110, is passed back through the return line 120 to the hydraulic fluid tank 60 where it can be returned to the pump 65 and reused in the hydrostatic drive system 50. Again, although FIGS. 2 and 3 illustrate a single control valve system 110 controlling the flow of hydraulic fluid through the right diverting conduit 104 and the left diverting conduit 102, if a separate control circuit was provided for each of the right diverting conduit 104 and left diverting conduit 102, a separate return line connected to each of the right diverting conduit 4 and the left diverting conduit 102 and returning to the tank 60 could be used, so that the right diverting conduit 104 and the left diverting conduit 102 do not have to be in relatively close physical proximity and connected to a signal control valve system 110.

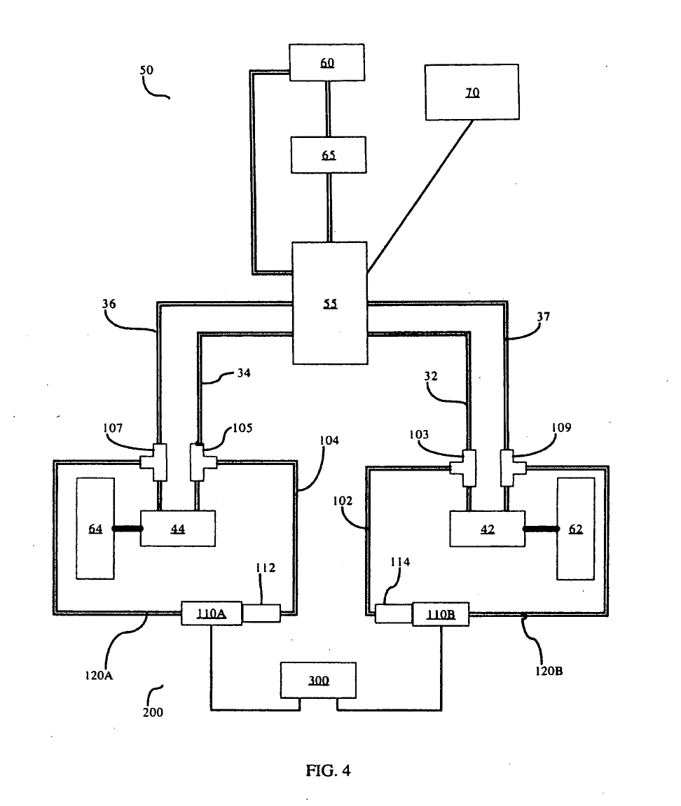

FIG. 4 illustrates a schematic of a variation of a steering system 200, incorporated into the hydrostatic drive system 50, illustrated in FIG. 1, in accordance with the present invention.

Steering system 200 is similar to the steering system 100, as shown in FIGS. 2 and 3, except that rather than routing diverted hydraulic fluid to the hydraulic fluid tank 60, through a single return conduit 120, a right return conduit 120A routes the diverted hydraulic fluid to the right return conduit 36 and a left return conduit 120B routes the diverted hydraulic fluid to the left return conduit 37. Typically, tee connections 107, 109 can be used to connect into the right return conduit 36 and the left return conduit 37. A right control valve system 110A controls the opening and closing of a flowpath through the right diverting conduit 104 and the right return conduit 120A, diverting hydraulic fluid flow around the right drive motor 44 and a left control valve system 110B controls the opening and closing of a flowpath through the left diverting conduit 102 and the left return conduit 120B, diverting hydraulic fluid flow around the right drive motor 42.

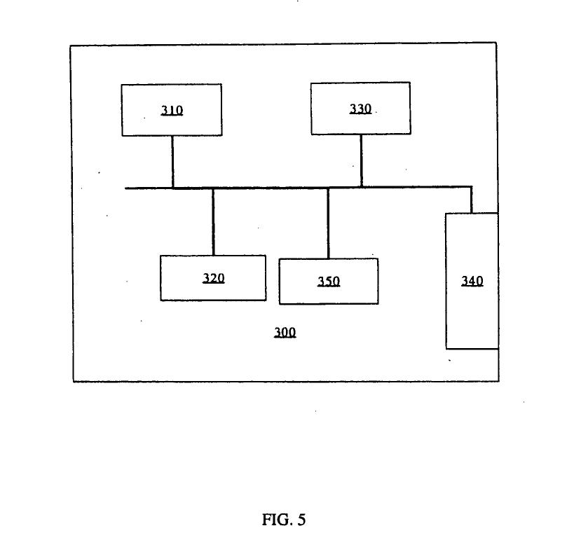

FIG. 5 illustrates a possible embodiment of control system 300, although a person skilled in the art will know that any control system operative to determine the position of a vehicle and transmit signals in response to the determined position could be used. Control system 300 comprises: a processor unit 310; such as a microprocessor; a position determining device 320, operative to determine a position of the vehicle, typically, the position determining device 320 is a GPS receiver that determines the position of the vehicle based on GPS signals; a memory 330, for storage of data; and an output interface 340. Generally, although not necessarily the control system 300 can also incorporate a direction determining device 350, such as a gyroscopic device that uses gyroscopes to determine a direction of travel. While FIG. 4 illustrates a control system 300 that uses a position determining device 320, such as a GPS receiver, to determine the position of the vehicle, it is contemplated that the control system 300 could use any type of method for determining its position such as dead reckoning, beacon referencing, etc.

The control system 300 is operative to determine a desired path of a vehicle in which the systems are installed and typically saves this desired path in the memory 330. As the vehicle is in operation, the control system 300 will repeatedly receive GPS signals using the position determining device 320 and determine the position of the vehicle. The processor unit 310 will compare the determined position of the vehicle with the desired path, to determine if the vehicle is following the desired path or has deviated from the course. Additionally, if the control system 300 comprises a direction determining device 350, the processor unit 310 will be able to determine the direction of travel of the vehicle and predict whether the direction of travel is causing the vehicle to leave the desired path.

Upon the processor unit 310 determining that the vehicle is not on or is leaving the desired path, the processor unit 310 will determine which way the vehicle has to be steered to either keep following the desired path or get back on the desired path, and the processor unit 310 will send an control signal through the output interface 340.

Referring to FIG. 3, the output signal transmitted by the control system 300 to the steering system 100 will be transmitted to the control valve system 110. The control system 300 will determine whether the vehicle is deviating from a desired path in either a right or left direction and provide a corresponding control signal to the control valve system 110 to steer the vehicle back to the desired path. Based on the control signal, the control valve system 110 will open a flow path for either the right diverting conduit 102 or left diverting conduit 102, causing the vehicle to turn. The control system 300 will continue to determine the position of the vehicle in relation to a desired path as the vehicle turns and once the vehicle has moved back to the desired path the control system 300 will stop sending a control signal to the control valve system 110 causing the control system 300 to stop steering the vehicle.

If the vehicle has deviated substantially from the desired path, the control system 300 may need to send a control signal to divert hydraulic fluid flow from either the left diverting conduit 102 or right diverting conduit 104 to reduce the rotation of the drive wheel 62, 64 on the opposite side of the vehicle to align the vehicle on the desired path.

The control signal transmitted from the control system 300 to the control circuit 110 is typically in the form of a voltage input. When the control valve system 110 receives a voltage input from the control system 300, the control valve system 110 opens a flow path and causes hydraulic fluid to flow through either the right diverting conduit 104 or left diverting conduit 102, until the voltage input stops. The control system 300 turns the vehicle to the right by sending a control signal to the control valve system 110 to open a flowpath for the right diverting conduit 104 causing the right diverting conduit 104 to route a portion of the hydraulic fluid flow away from the right hydraulic motor 44 and turns the vehicle to the left by sending a control signal to the control valve system 110 to open a flowpath for the left diverting conduit 102 causing the left diverting conduit 102 to route a portion of the hydraulic fluid flow away from the left hydraulic motor 42.

When the control system comprises a valve system that is either open or shut valves, the rate of turning can be altered by the sizing of the valve or valves in the valve system.

Using a larger valve or valves will divert more hydraulic fluid flow away from the hydraulic motors causing the vehicle to turn faster when the valves are opened. Alternatively, the right flowrate valve 112 and left flowrate valve 114 can be used to adjust the flowrate in the right diverting conduit 104 and the left diverting conduit 102 thereby altering the flowrate of hydraulic fluid flow way from the hydraulic motor and allowing the turning rate of the steering system 100 to be adjusted.

Alternatively, control valve system 110 can comprise a proportional valve or valves operative to open various amounts in response to control signals from the control system 300. For example, these control signals can be digital signals or analog signals specifying the degree of opening of the valve that is desired, whereby the amount the proportional valve opens will be based on the control signal from the control system 300. In this manner, the control system 300 would also be able to control the flowrate of hydraulic fluid through the right diverting conduit 104 and left diverting conduit 102 and in turn the turning rate of the vehicle. When the vehicle is only slightly deviating from the desired path, the control system 300 may only open the proportional valve or valves a slight amount to turn the vehicle slowly. Alternatively, if the vehicle is deviating significantly from the desired path, the control system 300 could open the proportional valve or valves a greater amount to cause the rate of turning of the vehicle to be greater.

Although a system of the present invention can easily be incorporated as original equipment, so that a vehicle could be manufactured with the control system 300 and the steering system 50, outlined herein. Alternatively, many of the control systems are provided as aftermarket kits to be added to a vehicle after it is purchased. It is contemplated within the scope of the invention that the steering system 100 could be made as part of a kit to be added to an existing vehicle with hydrostatic drive in conjunction with a control system, such as control system 300.

A method of steering a vehicle with a hydrostatic drive, independently of inputs from an operator, is also contemplated within the scope of the invention. Specifically, having a control system that monitors the current position of a vehicle and compares the vehicle's current position to a desired path. If the vehicle deviates from the current path, the control system will cause a portion of the flow of hydraulic fluid being routed to a hydraulic motor to drive a wheel of the vehicle to be diverted away from the hydraulic motor causing the motor to slow the rotation of the wheel it is driving and causing the vehicle to turn. The control system will continue to cause this hydraulic fluid to be diverted until the control system determines that the vehicle is no longer deviating from the desired path.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention

What is claimed is:

1. A vehicle with hydrostatic steering and an automatic steering system comprising;
a pressurized hydraulic fluid source;
a right hydraulic motor operative to drive a right drive wheel and operably connected to the pressurized hydraulic fluid source by a right drive conduit, wherein the right hydraulic motor is driven by a right hydraulic fluid flow from the right drive conduit;
a left hydraulic motor operative to drive a left drive wheel and operably connected to the pressurized hydraulic fluid source by a left drive conduit, wherein the left hydraulic motor is driven by a left hydraulic fluid flow from the left drive conduit;
a manual steering control for manual steering of the vehicle;
a hydraulic circuit operative to selectively vary the left hydraulic fluid flow and right hydraulic fluid flow, in response to inputs from the manual steering control;
a right diverting conduit operatively connected to the right drive conduit upstream from the right hydraulic motor;
a left diverting conduit operatively connected to the left drive conduit upstream from the left hydraulic motor;
a control system operative to determine a desired direction of travel and generate a control signal corresponding to the desired direction of travel; and
a control valve system operative to open a flow path through the right diverting conduit, in response to a right control signal from the control system and open a flow path through the left diverting conduit, in response to a left control signal from the control system;
wherein the vehicle can be automatically steered in a left direction by the control system generating a left control signal and the control valve system opening the flow path through the left diverting conduit in response to the left control signal to route a portion of the left hydraulic fluid flow away from the left drive motor and wherein the vehicle can be automatically steered in a right direction by the control system generating a right control signal and the control valve system opening the flow path through the right diverting conduit in response to the right control signal to route a portion of the right hydraulic fluid flow away from the right drive motor.

2. The vehicle of claim 1 wherein the control valve system contains at least one solenoid controlled valve.

3. The vehicle of claim 1 wherein the control valve system contains a first valve inline of the right diverting conduit and a second valve inline of the left diverting conduit.

4. The vehicle of claim 1 further comprising a first flowrate valve inline of the right diverting conduit to adjust the flowrate of a fluid flow in the right diverting conduit and a second flowrate valve inline of the left diverting conduit to adjust the flowrate of a fluid flow in the left diverting conduit.

5. The vehicle of claim 1 wherein the control valve system comprises at least one proportional valve capable of allowing a range of flowrates of a fluid flow through the at least one proportional valve in response to a control signal from the control system.

6. The vehicle of claim 5 wherein the control system is operative to generate a control signal that is a digital signal indicating a flowrate the proportional valve should allow.

7. The vehicle of claim 5 wherein the control system is operative to generate a control signal that is an analog signal indicating a flowrate the proportional valve should allow.

8. The vehicle of claim 1 wherein the control system comprises:
a position determining device, operative to determine a position of the vehicle;
an output interface operative to transmit a control signal to the control system; and
a processor unit, the processor unit operative to:
determine a desired path to be followed by the vehicle;
using information received from the position determining device, repeatedly monitor the position of the vehicle in relation to the desired path; and
in response to determining that the vehicle has deviated from the desired path, send a control signal to the control valve system to steer the vehicle back to the desired path.

9. The vehicle of claim 8 wherein the position determining device comprises a GPS receiver.

10. The vehicle of claim 9 wherein the position determining device further comprises a direction determining device.

11. The vehicle of claim 10 wherein the direction determining device comprises one or more gyroscopes.

12. A kit for adding automatic steering capabilities to a vehicle with hydrostatic steering, the vehicle comprising:
a pressurized hydraulic fluid source;
a right hydraulic motor operative to drive a right drive wheel and operably connected to the pressurized hydraulic fluid source by a right drive conduit,
wherein the right hydraulic motor is driven by a right hydraulic fluid flow from the right drive conduit;
a left hydraulic motor operative to drive a left drive wheel and operably connected to the pressurized hydraulic fluid source by a left drive conduit, wherein the left hydraulic motor is driven by a left hydraulic fluid flow from the left drive conduit;
a manual steering control for manual steering of the vehicle;
a hydraulic circuit operative to selectively vary the left hydraulic fluid flow and right hydraulic fluid flow, in response to inputs from the manual steering control; and
a control system operative to determine a desired direction of travel and generate a control signal corresponding to the desired direction of travel;
the kit comprising:
a right diverting conduit connectable to the right drive conduit of the vehicle upstream from the right hydraulic motor;
a left diverting conduit connectable to the left drive of the vehicle conduit upstream from the right hydraulic motor; and
a control valve system operatively connectable to the control system and operative to open a flow path through the right diverting conduit, in response to a right control signal from the control system and open a flow path through the left diverting conduit, in response to a left control signal from the control system;
wherein the kit allows the vehicle to be automatically steered in a left direction by the control system generating the left control signal and the control valve system opening the flow path through the left diverting conduit in response to the left control signal to route a portion of the left hydraulic fluid flow away from the left drive motor and wherein the vehicle can be automatically steered in a right direction by the control system generating the right control signal and the control valve system opening the flow path through the right diverting conduit in response to the right control signal to route a portion of the right hydraulic fluid flow away from the right drive motor.

13. The kit of claim 12 wherein the control valve system contains at least one solenoid controlled valve.

14. The kit of claim 12 wherein the control valve system contains a first valve inline of the right diverting conduit and a second valve inline of the left diverting conduit.

15. The kit of claim 12 further comprising a first flowrate valve inline of the right diverting conduit to adjust the flowrate of a fluid flow in the right diverting conduit and a second flowrate valve inline of the left diverting conduit to adjust the flowrate of a fluid flow in the left diverting conduit.

16. The kit of claim 12 wherein the control valve system comprises at least one proportional valve operative, capable of allowing a range of flowrates of a fluid flow through the at least one proportional valve in response to a control signal from the control system.

17. The kit of claim 16 wherein the control valve is operative to receive a control signal from the control system that is a digital signal and opening the proportional valve to allow a flowrate in relation to the control signal.

18. The kit of claim 16 wherein the control valve is operative to receive a control signal from the control system that is an analog signal and opening the proportional valve o allow a flowrate in relation to the control signal.

19. A method of automatically steering a vehicle equipped with hydrostatic steering on a desired path, the method comprising:
determining a steering direction required to steer the vehicle on the desired path; and
automatically diverting a portion of a hydraulic fluid flow flowing to a hydraulic motor driving a wheel of the vehicle to slow the wheel to steer the vehicle in the steering direction.

20. The method of claim 19 wherein the steering direction is determined by monitoring the position of the vehicle as it travels along the desired path, and, when the vehicle deviates from the desired path using a steering direction that causes the vehicle to move toward the desired path.

21. The method of claim 20 wherein, when the vehicle moves onto the desired path, diverting away a portion of a hydraulic flow to a hydraulic motor driving a wheel on an opposite side of the vehicle to align the vehicle on the desired path.
